(19) United States
(12) Patent Application Publication
(10) Pub. No.: US 2020/0340604 A1
(43) Pub. Date: Oct. 29, 2020

(54) PIPE COUPLING AND METHOD

(71) Applicants: Pablo Guerra, Conroe, TX (US); Adam Bosch, Campton Hills, IL (US)

(72) Inventors: Pablo Guerra, Conroe, TX (US); Adam Bosch, Campton Hills, IL (US)

(21) Appl. No.: 16/860,630

(22) Filed: Apr. 28, 2020

Related U.S. Application Data
(60) Provisional application No. 62/839,890, filed on Apr. 29, 2019.

(51) Int. Cl. F16L 15/00; F16L 15/08

(52) U.S. Cl. CPC F16L 15/002; F16L 15/08

(57) ABSTRACT

A threaded coupling and associated methods are disclosed. In one example, a threaded coupling includes an inner threaded coupling and an outer threaded coupling. In one example, a thread orientation between the inner threaded coupling and the outer threaded coupling is reversed. A locked threaded coupling results from configurations disclosed.

### PRIORITY

This application claims the benefit of priority to U.S. Provisional Patent Application Ser. No. 62/839,890, filed Apr. 29, 2019, which is incorporated by reference herein in its entirety.

### TECHNICAL FIELD

Embodiments described herein generally relate to threaded couplings and methods. One specific example includes threaded couplings for underground drill string segments. Other specific examples include, but are not limited to, drill pipe in oil drilling, water well drilling, geotechnical investigation drilling, etc.

### BACKGROUND

Secure connections between detachable rods in several different settings are desirable. In one particular example, underground drill strings require a secure connection between segments. Drilling operations are more effective when the drill string can be reliably manipulated in both a clockwise and a counter clockwise direction. Existing drill string connections include threaded connections. When a threaded connection is rotated in a counter clockwise direction, one or more joints in the drill string may break free and loosen or separate. Improved threaded connections and methods are desired that address these concerns, and other technical challenges. Although drill strings are used as an example, embodiments of threaded connections described in the present disclosure are applicable to numerous other applications.

### BRIEF DESCRIPTION OF THE DRAWINGS

FIG. 1A shows an exploded view of a cylindrical coupling in accordance with some example embodiments.

FIG. 1B shows a close up view of a portion of a cylindrical coupling in accordance with some example embodiments.

FIG. 2 shows a cross section of a cylindrical coupling in accordance with some example embodiments.

FIG. 3 shows a drill string segment in accordance with some example embodiments.

FIGS. 4A-4D show cross sections of an operation of securing a cylindrical coupling in accordance with some example embodiments.

FIG. 5 shows a flow diagram of a method of coupling in accordance with some example embodiments.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

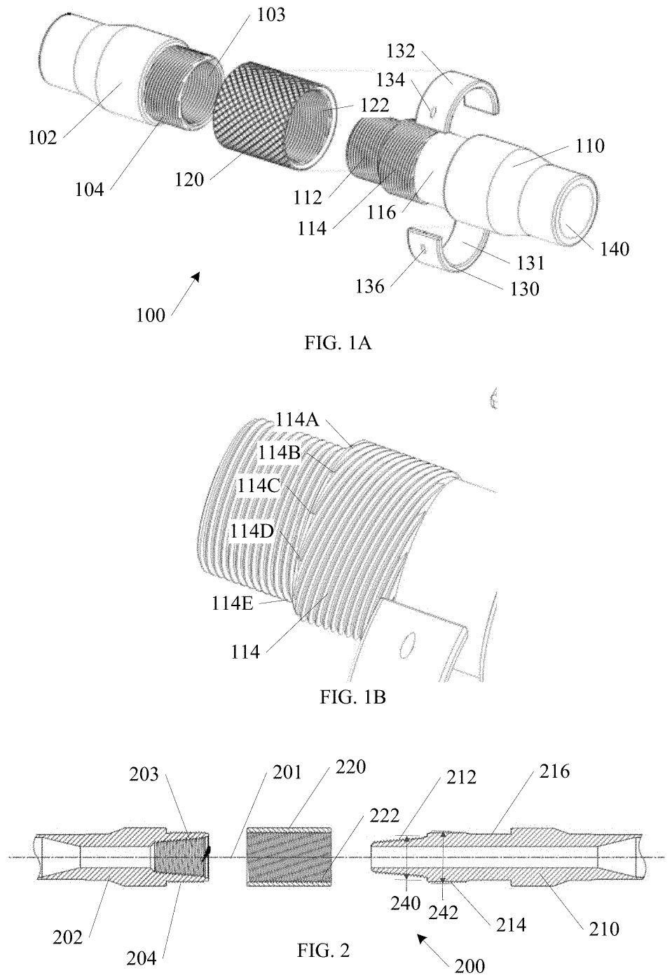

FIG. 1A shows a cylindrical coupling 100 according to one example. A first coupling portion 102 and a second coupling portion 110 are shown. In one example, the first coupling portion 102 and the second coupling portion 110 are each further coupled to rod portions of drill string segment, although the invention is not so limited. The first coupling portion 102 includes a female threaded interface 103 of an inner threaded coupling. The second coupling portion 110 includes a male threaded interface 112 of an inner threaded coupling. The first coupling portion 102 further includes a male threaded interface 104 of an outer threaded coupling. The second coupling portion 110 includes a male threaded interface 114 of an outer threaded coupling. A collar 120 is further shown, the collar 120 having a female threaded interface 122 that corresponds to both the male threaded interfaces 104 and 114 of the outer threaded coupling.

In one example, the threaded interface 114 includes multiple starts. FIG. 1B shows a number of starts 114A, 114B, 114C, 114D, 114E in the threaded interface 114. In the example shown, twelve separate starts are included in the male threaded interface 114, although the invention is not so limited. Other numbers of multiple starts are also within the scope of the invention. The inclusion of multiple thread starts better accommodates a condition where the female threaded interface 103 and the male threaded interface 112 may tighten to a different rotational location in different couplings 100 due to dirt, different torques, variations in coupling 100 manufacture dimensions, etc. One of the multiple starts is more likely to line up with the threaded interface 122 of the collar 120 within an acceptable rotational variance.

A first retainer block 130 and a second retainer block 132 are further shown in FIG. 1A. In operation, as described in more detail below, the retainer blocks 130, 132 may be used to prevent unwanted motion of the collar 120, and to prevent unwanted dirt or debris from contaminating one or more of the threaded couplings. In one example, a bolt, screw, or other fastener may be used in openings 134, 136 to hold the first retainer block 130 together with the second retainer block 132. Other fastening devices/methods are also within the scope of the invention. Additionally, although two retaining blocks are shown in this example, the invention is not so limited. Other examples include a single retaining block or more than two portions of a retaining block.

FIG. 1A further shows an internal passageway 140. In selected examples, a liquid, gas or other media may be routed through the internal passageway 140 of a drill string. One example includes a lubricant, such as bentonite slurry or other drilling fluid.

FIG. 2 shows a cross section view of a cylindrical coupling 200, similar to the coupling described in FIG. 1. A first coupling portion 202 and a second coupling portion 210 are shown. The first coupling portion 202 includes a female threaded interface 203 of an inner threaded coupling. The second coupling portion 210 includes a male threaded interface 212 of the inner threaded coupling. In the example shown, the female threaded interface 203 and the male threaded interface 212 mate together to form the inner threaded coupling. In one example, the female threaded interface 203 and the male threaded interface 212 each include mating tapered threads as illustrated in FIG. 2. Tapered threads form a cone like section, and provide for a tighter threaded connection than conventional cylindrical threads. While tapered threads can provide a tighter connection, they may require higher forces to loosen the connection when disassembling a drill string. In the example of FIG. 2, a first thread diameter 240 is indicated for the inner threaded coupling. In one example, the inner threaded coupling includes a first thread orientation, for example, right hand threaded or left hand threaded.

The first coupling portion 202 includes a first male threaded interface 204 of an outer threaded coupling. The second coupling portion 210 includes a second male threaded interface 214 of the outer threaded coupling. In the example shown, the first male threaded interface 204 and the second male threaded interface 214 abut one another and align to cooperate as a single thread. A collar 220 is further included, with a female thread 222 that is dimensioned to complete an outer threaded coupling. The collar 220 may be selectively threaded over one or both of the first male threaded interface 204 and the second male threaded interface 214. In one example, the collar includes one or more tooling interfaces to aid in rotation of the collar as described in examples of the present disclosure. Tooling interfaces may include, but are not limited to, pin holes for insertion of a tooling pin, wrench flats for engagement with a large hex end wrench, a smoothed or textured region for application of a pipe wrench, etc.

In the example of FIG. 2, a second thread diameter 242 is indicated for the outer threaded coupling. The second thread diameter 242 is larger than the first thread diameter 240 of the inner threaded coupling. The difference in diameter allows the outer threaded coupling to be separately operated over an outside of the inner threaded coupling. In the example shown, the inner threaded coupling is concentric with the outer threaded coupling, and both the inner threaded coupling and the outer threaded coupling are concentric with a central coupling axis 201.

In one example, the first male threaded interface 204 and the second male threaded interface 214 each include cylindrical threads as illustrated in FIG. 2. The cylindrical threads are easier to move in either rotational direction than a tapered thread. In one example, the outer threaded coupling includes a second thread orientation that is opposite the first thread orientation of the inner threaded coupling. With a thread orientation that is opposite the inner threaded coupling, when the collar 220 covers a portion of both the first male threaded interface 204 and the second male threaded interface 214, a locking function is provided. The locking function facilitates both clockwise rotation and counterclockwise rotation of a drill string, without a possibility for a connection at the coupling to loosen at an undesirable time. This function will be described in greater detail in Examples of FIGS. 4A-4D below.

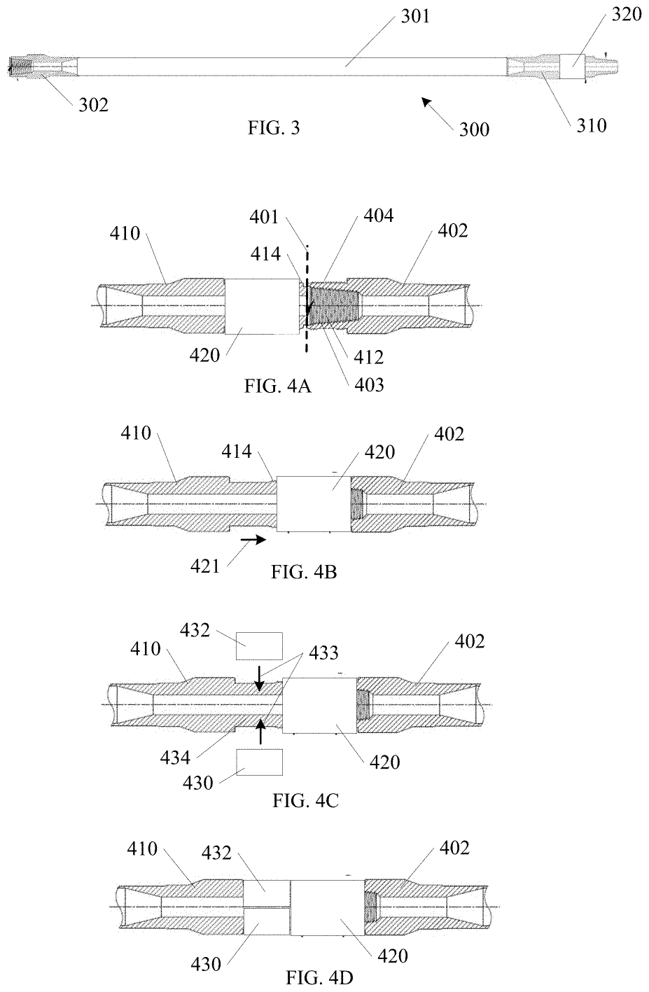

FIG. 3 shows a drill string segment 300 including cylindrical connection components as described in examples above. The drill string segment 300 includes a first coupling portion 302 and a second coupling portion 310. A rod 301 is located between the first coupling portion 302 and the second coupling portion 310. In selected examples, the first coupling portion 302 and the second coupling portion 310 are welded to the rod 301, although the invention is not so limited. In other examples, the first coupling portion 302 and the second coupling portion 310 may be integrally formed, for example by forging or rolling. In other examples, mechanical fastening methods such as threads or bolts, etc. may be used for attachment to rod 301. In one example, an adhesive, such as epoxy may provide additional attachment strength.

A collar 320 is shown at a right hand side of the Figure, as a portion of the second coupling portion 310. In one example, each drill string segment includes a movable collar 320 to secure a drill string connection as described above, and as illustrated below with respect to FIGS. 4A-4D.

FIG. 4A shows a cross section of a first stage of a coupling operation according to one example. In FIG. 4A, a first coupling portion 402 and a second coupling portion 410 are threaded together along an inner threaded coupling. A joint interface 401 is shown after the inner threaded coupling is secured. Similar to examples described above, the inner threaded coupling includes a male threaded portion 403 and a female threaded portion 412. In one example, the inner threaded coupling is threaded in a first thread orientation, for example, left handed or right handed.

A first male threaded portion 404 and a second male threaded portion 414 are shown forming a male part of an outer threaded coupling similar to examples described above. A collar 420 is shown located over only the second male threaded portion 414 of the second coupling portion 410 at the stage described in FIG. 4A.

In FIG. 4B, the collar 420 is rotated over the first male threaded portion 404 of the first coupling portion 402. In the stage described in FIG. 4B, the collar 420 covers a portion of both the first male threaded portion 404 and the second male threaded portion 414. In one example, the collar 420 is threaded over the first male threaded portion 404 and the second male threaded portion 414 using a second thread orientation that is opposite the first thread orientation. For example, if the first thread orientation is right handed, then the second thread orientation is left handed. Further, if the first thread orientation is left handed, then the second thread orientation is right handed.

Once the coupling is in the condition shown in FIG. 4B, the coupling is rotationally locked. As a result of the opposite threadings between the first threaded coupling and the second threaded coupling, if the drill string is rotated in a direction that would tend to loosen the inner threaded coupling, then such rotation would also tighten the outer threaded coupling. Likewise, if the drill string is rotated in a direction that would tend to loosen the outer threaded coupling, then such rotation would also tighten the inner threaded coupling. As a result, a drill string using couplings as described in the present disclosure may be easily locked, and once locked, they may be securely rotated either clockwise or counterclockwise without risk of any coupling connections coming loose.

In selected specific examples, the couplings described in the present disclosure are of particular use in “fishing” applications that require drill stem to be rotated counter clockwise. The couplings described in the present disclosure are also of particular use in applications where drill pipe is used in horizontal directional drilling connected to a “catch rig” that require counter clockwise rotation.

FIG. 4C shows an example that further includes a retainer block. In the example shown, a first retainer block 430 and a second retainer block 432 are placed over region 434 of the second coupling portion 410. Although two retaining blocks are shown in this example, the invention is not so limited. Other examples include a single retaining block or more than two portions of a retaining block. Placement of the first retainer block 430 and the second retainer block 432 is indicated by arrows 433.

FIG. 4D shows the first retainer block 430 and the second retainer block 432 secured in place. As can be seen from the Figure, the collar 420 is blocked from movement along the first male threaded portion 404 and the second male threaded portion 414 by the first retainer block 430 and the second retainer block 432. Additionally, the first retainer block 430 and the second retainer block 432 are effective to prevent unwanted dirt or debris from contaminating one or more of the threaded couplings.

It should be noted that while female and male threads are shown on respective components in examples above, the invention is not limited to the example in the figures. The invention also includes examples where female and male threads are reversed in all or selected locations of examples described in the figures.

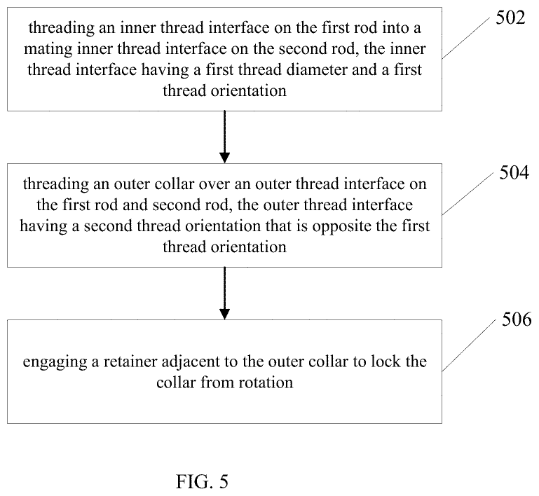

FIG. 5 shows a flow diagram of a method of coupling a first rod and a second rod. In operation 502, an inner thread interface is threaded on a first rod into a mating inner thread interface on a second rod, the inner thread interface having a first thread diameter and a first thread orientation. In operation 504, an outer collar is threaded over an outer thread interface on the first rod and the second rod, the outer thread interface having a second thread orientation that is opposite the first thread orientation. In operation 506, a retainer is further engaged adjacent to the outer collar to lock the collar from rotation.

To better illustrate the fans and methods disclosed herein, a non-limiting list of embodiments is provided here:

Example 1 includes a cylindrical coupling. The coupling includes a first rod and a second rod positioned end to end at a joint interface, an inner threaded coupling connecting the first rod to the second rod at the joint interface, the inner threaded coupling having a first thread orientation and a first thread diameter, and an outer threaded coupling further connecting the first rod to the second rod at the joint interface the outer threaded coupling having a second thread diameter that is larger than the first thread diameter, wherein the outer threaded coupling has a second thread orientation that is opposite the first thread orientation.

Example 2 includes the cylindrical coupling of example 1, wherein the outer threaded coupling includes a male thread portion on both the first rod and the second rod, and wherein the outer threaded coupling further includes a mating female thread collar to engage with the male thread portions on both the first rod and the second rod.

Example 3 includes the cylindrical coupling of any one of examples 1-2, wherein the collar includes a tooling interface to accept a wrench.

Example 4 includes the cylindrical coupling of any one of examples 1-3, wherein the tooling interface includes a hex wrench interface.

Example 5 includes the cylindrical coupling of any one of examples 1-4, wherein the tooling interface includes one or more holes in the collar.

Example 6 includes the cylindrical coupling of any one of examples 1-5, wherein the inner threaded coupling includes a tapered thread.

Example 7 includes the cylindrical coupling of any one of examples 1-6, wherein the first thread orientation is a right hand thread, and the second thread orientation is a left hand thread.

Example 8 includes the cylindrical coupling of any one of examples 1-7, further including a retainer block to selectively lock the outer threaded coupling from rotation.

Example 9 includes the cylindrical coupling of any one of examples 1-8, wherein the retainer block includes two mating collar portions configured to fit over the first rod.

Example 10 includes a drill stem segment. The drill string segment includes an inner threaded interface at a first end of the drill stem segment, the inner threaded interface having a first thread orientation and a first thread diameter, and an outer threaded interface at the first end of the drill stem segment, the outer threaded interface having a second thread diameter that is larger than the first thread diameter, wherein the outer threaded coupling has a second thread orientation that is opposite the first thread orientation.

Example 11 includes the drill stem segment of example 10, wherein the inner threaded interface is female and the outer threaded interface is male.

Example 12 includes the drill stem segment of any one of examples 10-11, wherein the inner threaded interface is male and the outer threaded interface is male.

Example 13 includes the drill stem segment of any one of examples 10-12, further including an inner threaded interface at a second end of the drill stem segment, the inner threaded interface having a first thread orientation and a first thread diameter, and an outer threaded interface at the second end of the drill stem segment, the outer threaded interface having a second thread diameter that is larger than the first thread diameter, wherein the outer threaded coupling has a second thread orientation that is opposite the first thread orientation.

Example 14 includes the drill stem segment of any one of examples 10-13, wherein at the first end, the inner threaded interface is female and the outer threaded interface is male, and wherein at the second end, the inner threaded interface is male and the outer threaded interface is male.

Example 15 includes the drill stem segment of any one of examples 10-14, wherein the inner threaded interface at both the first end and the second end is a tapered thread.

Example 16 includes the drill stem segment of any one of examples 10-15, further including a mating female thread collar to engage with the outer threaded interface.

Example 17 includes the drill stem segment of any one of examples 10-16, further including an internal passageway through a central portion of the drill stem segment to transmit a lubricant.

Example 18 includes a method of coupling a first rod and a second rod. The method includes threading an inner thread interface on the first rod into a mating inner thread interface on the second rod, the inner thread interface having a first thread diameter and a first thread orientation, and threading an outer collar over an outer thread interface on the first rod and second rod, the outer thread interface having a second thread orientation that is opposite the first thread orientation.

Example 19 includes the method of example 18, wherein threading the inner thread interface on the first rod into the mating inner thread interface on the second rod includes threading a tapered thread interface on the first rod into a mating tapered thread interface on the second rod.

Example 20 includes the method of any one of examples 18-19, further including engaging a retainer adjacent to the outer collar to lock the collar from rotation.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A cylindrical coupling, comprising:
a first rod and a second rod positioned end to end at a joint interface;
an inner threaded coupling connecting the first rod to the second rod at the joint interface, the inner threaded coupling having a first thread orientation and a first thread diameter; and
an outer threaded coupling further connecting the first rod to the second rod at the joint interface the outer threaded coupling having a second thread diameter that is larger than the first thread diameter, wherein the outer threaded coupling has a second thread orientation that is opposite the first thread orientation.

2. The cylindrical coupling of claim 1, wherein the outer threaded coupling includes a male thread portion on both the first rod and the second rod, and wherein the outer threaded coupling further includes a mating female thread collar to engage with the male thread portions on both the first rod and the second rod.

3. The cylindrical coupling of claim 1, wherein the collar includes a tooling interface to accept a wrench.

4. The cylindrical coupling of claim 3, wherein the tooling interface includes a hex wrench interface.

5. The cylindrical coupling of claim 3, wherein the tooling interface includes one or more holes in the collar.

6. The cylindrical coupling of claim 1, wherein the inner threaded coupling includes a tapered thread.

7. The cylindrical coupling of claim 1, wherein the first thread orientation is a right hand thread, and the second thread orientation is a left hand thread.

8. The cylindrical coupling of claim 1, further including a retainer block to selectively lock the outer threaded coupling from rotation.

9. The cylindrical coupling of claim 8, wherein the retainer block includes two mating collar portions configured to fit over the first rod.

10. A drill stem segment, comprising:
an inner threaded interface at a first end of the drill stem segment, the inner threaded interface having a first thread orientation and a first thread diameter; and
an outer threaded interface at the first end of the drill stem segment, the outer threaded interface having a second thread diameter that is larger than the first thread diameter, wherein the outer threaded coupling has a second thread orientation that is opposite the first thread orientation.

11. The drill stem segment of claim 10, wherein the inner threaded interface is female and the outer threaded interface is male.

12. The drill stem segment of claim 10, wherein the inner threaded interface is male and the outer threaded interface is male.

13. The drill stem segment of claim 10, further including an inner threaded interface at a second end of the drill stem segment, the inner threaded interface having a first thread orientation and a first thread diameter; and
an outer threaded interface at the second end of the drill stem segment, the outer threaded interface having a second thread diameter that is larger than the first thread diameter, wherein the outer threaded coupling has a second thread orientation that is opposite the first thread orientation.

14. The drill stem segment of claim 13, wherein at the first end, the inner threaded interface is female and the outer threaded interface is male; and
wherein at the second end, the inner threaded interface is male and the outer threaded interface is male.

15. The drill stem segment of claim 10, wherein the inner threaded interface at both the first end and the second end is a tapered thread.

16. The drill stem segment of claim 15, further including a mating female thread collar to engage with the outer threaded interface.

17. The drill stem segment of claim 16, further including an internal passageway through a central portion of the drill stem segment to transmit a lubricant.

18. A method of coupling a first rod and a second rod, comprising:
threading an inner thread interface on the first rod into a mating inner thread interface on the second rod, the inner thread interface having a first thread diameter and a first thread orientation; and
threading an outer collar over an outer thread interface on the first rod and second rod, the outer thread interface having a second thread orientation that is opposite the first thread orientation.

19. The method of claim 18, wherein threading the inner thread interface on the first rod into the mating inner thread interface on the second rod includes threading a tapered thread interface on the first rod into a mating tapered thread interface on the second rod.

20. The method of claim 19, further including engaging a retainer adjacent to the outer collar to lock the collar from rotation.
